(19) United States
(12) Patent Application Publication
(10) Pub. No.: US 2024/0357678 A1
(43) Pub. Date: Oct. 24, 2024

(54) DEVICE DISCOVERY METHOD AND APPARATUS, AND STORAGE MEDIUM

(71) Applicant: Beijing Xiaomi Mobile Software Co., Ltd., Beijing (CN)

(72) Inventor: Xiandong DONG, Beijing (CN)

(21) Appl. No.: 18/577,150

(22) PCT Filed: Jul. 7, 2021
(86) PCT No.: PCT/CN2021/104959

§ 371 Date: Jan. 5, 2024

(51) Int. Cl. H04W 76/15

(52) U.S. Cl. CPC H04W 76/15

(57) ABSTRACT

A device discovery method and apparatus, and a storage medium. The device discovery method includes: receiving, through a target link with a wireless access point (AP), a fast initial link setup discovery (FD) frame sent by the AP; and determining an AP multi-link device (MLD) is discovered under the target link determining at least a first information element is encapsulated in the FD frame, the first information element is configured to indicate a multi-link communication capability corresponding to the AP MLD.

### CROSS REFERENCE

The present application is a U.S. National Stage of International Application No. PCT/CN2021/104959, entitled “DEVICE DISCOVERY METHOD AND APPARATUS, AND STORAGE MEDIUM”, filed on PCT Jul. 7, 2021, the contents of all of which are incorporated herein by reference in their entireties for all purposes.

### BACKGROUND

Institute of Electrical and Electronics Engineers (IEEE) 802.11 established IEEE802.11be Study Group (SG) for studying a next generation of mainstream (802.11a/b/g/n/ac) wireless fidelity (Wi-Fi) technology, the scope of study is: bandwidth transmission of 320 megahertz (MHz), and multi-frequency band aggregation and collaboration, etc, and expects a rate and a throughput are at least four times higher than those of existing 802.11ax. The technology is applied to video transmission, augmented reality (AR), virtual reality (VR), etc. The multi-frequency band aggregation and collaboration (connection) means devices (terminal devices in most cases) communicate with each other in frequency bands of 2.4 GHz, 5 GHZ and 6 GHZ-7 GHz at the same time, for the simultaneous multi-frequency band communication between devices, a new media access control (MAC) mechanism is defined for management, another expectation of IEEE802.11be is to support low-delay transmission.

In 802.11be, a maximum bandwidth to be supported is 320 MHz (160 MHz+160 MHz), followed by 240 MHz (160 MHz+80 MHz), a bandwidth supported in 802.11ax may be defined in the future.

### SUMMARY

The disclosure relates to the field of communication, in particular to device discovery method and apparatus, and storage medium.

According to a first aspect of the disclosure, a device discovery method is provided, the method is performed by a wireless access point (AP) supporting multi-link communication, and includes:
generating a fast initial link setup discovery (FD) frame, where at least a first information element is encapsulated in the FD frame, and the first information element is configured to indicate a multi-link communication capability corresponding to an AP multi-link device (MLD); and
sending, through a target link between the AP and a station (STA), the FD frame in which at least the first information element is encapsulated to the STA.

According to a second aspect of the disclosure, a device discovery method is provided, the method is performed by a station (STA), and includes:
receiving, through a target link with a wireless access point (AP), a fast initial link setup discovery (FD) frame sent by the AP; and
determining at least a first information element is encapsulated in the FD frame, determining an AP multi-link device (MLD) is discovered under the target link, where the first information element is configured to indicate a multi-link communication capability corresponding to the AP MLD.

According to a third aspect of the disclosure, a non-transitory computer-readable storage medium is provided, the computer-readable storage medium stores a computer program, where the computer program is configured to execute any said device discovery method at an AP side.

According to a fourth aspect of the disclosure, a non-transitory computer-readable storage medium is provided, the computer-readable storage medium stores a computer program, where the computer program is configured to execute any said device discovery method at an STA side.

According to a fifth aspect of the disclosure, a first device discovery apparatus is provided, the first device discovery apparatus includes:
a first processor; and
a first memory configured to store a processor-executable instruction; where
the first processor is configured to execute any said device discovery method at an AP side.

According to an sixth aspect of the disclosure, a second device discovery apparatus is provided, the second device discovery apparatus includes:
a second processor; and
a second memory configured to store a processor-executable instruction; where
the second processor is configured to execute any said the device discovery method at an STA side.

It should be understood that the above general description and the following detailed description are illustrative and explanatory, and cannot limit the disclosure.

### BRIEF DESCRIPTION OF THE DRAWINGS

The drawings here are incorporated into the description as a constituent part of the description, illustrate examples conforming to the disclosure, and serve to explain principles of the disclosure along with the description.

FIG. 1 is a schematic flowchart of a device discovery method according to an example.

FIGS. 2A-2F are schematic diagrams of frame structures according to an example.

FIG. 3 is a schematic flowchart of another device discovery method according to an example.

FIG. 4 is a schematic flowchart of yet another device discovery method according to an example.

FIG. 5 is a schematic flowchart of yet another device discovery method according to an example.

FIG. 6 is a schematic flowchart of yet another device discovery method according to an example.

FIG. 7 is a schematic flowchart of still another device discovery method according to an example.

FIG. 8 is a block diagram of a device discovery apparatus according to an example.

FIG. 9 is a block diagram of another device discovery apparatus according to an example.

FIG. 10 is a schematic structural diagram of a device discovery apparatus according to an example of the disclosure.

FIG. 11 is a schematic structural diagram of another device discovery apparatus according to an example of the disclosure.

### DETAILED DESCRIPTION

Examples will be described in detail here, and their instances are shown in the accompanying drawings. When the following description involves the accompanying drawings, the same numerals in different accompanying drawings indicate the same or similar elements unless otherwise indicated. Embodiments described in the following examples do not represent all embodiments consistent with the disclosure. On the contrary, these embodiments are instances of apparatuses and methods that are detailed in the appended claims and consistent with some aspects of the disclosure.

Terms used in the disclosure are used for describing specific examples rather than limiting the disclosure. As used in the disclosure and the appended claims, the singular forms such as “a”, “an”, “the” and “this” are also intended to include plural forms, unless otherwise clearly stated in the context. It should also be understood that the term “and/or” used in the description refers to and includes any or all possible combinations of at least one associated listed item.

It should be understood that although terms such as first, second and third can be used in the disclosure to describe different kinds of information, the information should not be limited to these terms. These terms are used to distinguish the same type of information from each other. For example, first information can also be referred to as second information, and similarly, second information can also be referred to as first information, without departing from the scope of the disclosure. Depending on the context, the word “if” as used here can be interpreted as “at the time of” or “when” or “determining”.

At present, as defined in 802.11be, a device can support a fast initial link setup (FILS) function. In addition, in the previous 802.11 standard, an FILS discovery (FD) frame is also defined in order to make the device to be discovered rapidly. In order to facilitate rapid discovery of a wireless access point (AP), a format of the FD frame is also integrated and extended.

However, a current FD frame cannot be applied to an AP multi-link device (MLD). An affiliated AP in the AP MLD can communicate with different stations (STA) through a plurality of concurrent communication links, and the communication links can have different bandwidths. For example, the affiliated AP communicates with STA1 through a 2.4 GHz communication link, with STA2 through a 5 GHz communication link, and with STA3 through a 6 GHz communication link. The plurality of communication links are combined to form the AP MLD. communication links correspond to affiliated APs in a one-to-one correspondence manner.

To overcome the problems in related art, examples of the disclosure provide a device discovery method and apparatus, and a storage medium.

The disclosure provides a device discovery solution, through which the AP MLD can be rapidly discovered under one link, and establishment of multi-link communication is facilitated accordingly.

A device discovery solution according to the disclosure will be introduced below from an AP side at first.

With reference to FIG. 1, FIG. 1 is a flowchart of a device discovery method according to an example. The method may be performed by an AP supporting multi-link communication. In some examples, the AP is an affiliated AP of an AP MLD device. The method may include:

Step 101, an FD frame is generated, where at least a first information element is encapsulated in the FD frame, and the first information element is configured to indicate a multi-link communication capability corresponding to an AP multi-link device (MLD).

In the example of the disclosure, the AP may at least encapsulate the first information element in the FD frame, and in some examples, the first information element may be a multi-link (ML) information element.

Step 102, the FD frame in which at least the first information element is encapsulated is sent to a station (STA) through a target link between the AP and the STA.

In a possible embodiment, the AP may send the FD frame within a period of a beacon frame, or may send the FD frame within a time period after a previous beacon frame is sent and before a next beacon is sent.

In the example of the disclosure, the AP may send the FD frame in which at least the first information element is encapsulated to a certain STA through a target link established with the STA. The STA may be an STA affiliated with the STA MLD. While the device is rapidly discovered, the STA is informed of the AP supports multi-link communication, such that AP MLD can be quickly discovered by the STA MLD under the target link, and multi-link communication is established.

In the above example, the AP MLD can be rapidly discovered by the STA MLD under one link, such that establishment of multi-link communication is facilitated.

In the example of the disclosure, the AP supporting multi-link communication can generate the FD frame, and at least the first information element indicating the multi-link communication capability corresponding to the AP MLD is encapsulated in the generated FD frame. Then, the FD frame in which at least the first information element is encapsulated is sent to the STA through the target link between the AP and the STA, and the STA can quickly discover the AP MLD based on the first information element encapsulated in the FD frame. The AP MLD can be rapidly discovered by an STA MLD under one link, such that establishment of multi-link communication is facilitated.

In some examples, the FD frame may encapsulate the first information element in a manner, for example, as shown in Table 1.

TABLE 1

| Order | Information | Notes |
|---|---|---|
| . . . | . . . | . . . |
| n | First information | The ML element is present in the presence of |
| | element (ML | support for a multi-link communication |
| | element) | capability, otherwise the ML element is not |
| | | present. |

Where, n is a positive integer.

In some examples, a second information element is further encapsulated in the FD frame, and the second information element is configured to indicate support for a target service. In some examples, the second information element may be a restricted target wake-up time (RTWT) information element. When the first information element and the second information element are encapsulated in the FD frame at the same time, an encapsulation manner is, for example, shown in Table 2.

TABLE 2

| Order | Information | Notes |
|---|---|---|
| . . . | . . . | . . . |
| n | First information | The ML element is present in the presence of |
| | element (ML | support for a multi-link communication |
| | element) | capability, otherwise the ML element is not |
| | | present. |
| n + 1 | Second information | The rTWT element is present when a target |
| | element (rTWT | service is supported, otherwise the rTWT |
| | element) | element is not present. |

Where, n is a positive integer.

In a possible embodiment, the target service includes, but is not limited to, a low-delay service, such as an autonomous driving service.

In the above example, a second information element is further encapsulated in an FD frame generated by the AP to indicate the AP supports the target service, and high usability is achieved.

In some examples, since the AP supports multi-link communication, at least a reduced neighbor report (RNR) information element is further encapsulated in the FD frame. Accordingly, the first information element at least includes a first subdomain, and a bit value included in the first subdomain may be a preset value.

In a possible embodiment, the first subdomain is a subdomain indicating whether a basic service set (BSS) change sequence (for example, a BSS change sequence present subdomain) is present, and the preset value may be “0” for indicating the BSS change sequence is not present.

Further, a common information (common info) domain of the first information element does not include a second subdomain indicating a BSS parameters change count. The second subdomain may be a BSS parameters change count subdomain.

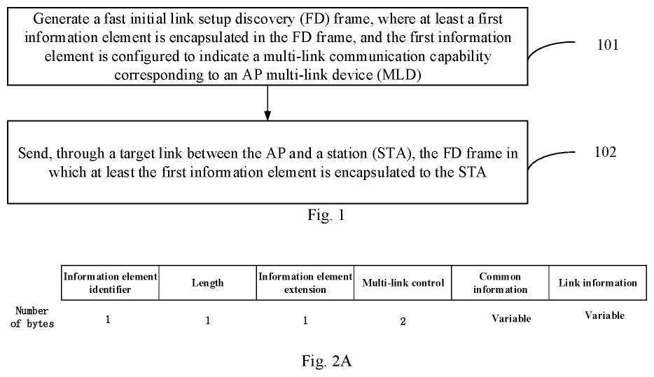

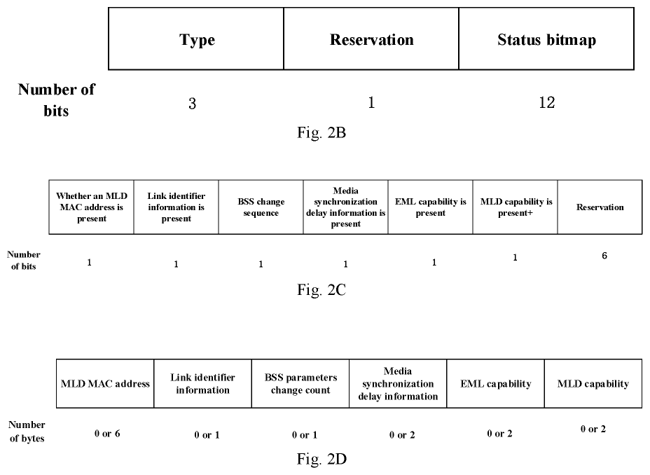

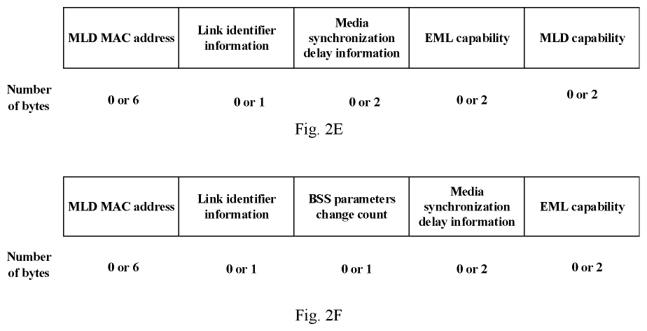

In the example of the disclosure, a structure of the first information element may be as shown in FIG. 2A, for example, and at least includes information domains such as an information element identifier, a length, information element extension, Multi-link control, common information, link information, etc. A structure of the Multi-link control domain may include, as shown in FIG. 2B, for example, three subdomains: a type, reservation and a status bitmap. For example, as shown in FIG. 2C, a structure of the status bitmap subdomain at least includes the first subdomain indicating whether the BSS change sequence (that is, the BSS change sequence present subdomain) is present. In the example of the disclosure, the bit value included in the first subdomain may be a preset value of “0” for indicating the BSS change sequence is not present. Since the AP supports the multi-link communication, identifiers of BSS corresponding to a plurality of APs attached to the AP MLD need to be consistent, and no change is needed. As a result, the first subdomain may be set as a preset value for indicating the BSS change sequence is not present.

Accordingly, a structure of the common information domain is shown in, for example, FIG. 2D. When the bit value included in the first subdomain is the preset value of “0”, the common information domain does not include the second subdomain indicating the BSS parameters change count, that is, the second subdomain indicating the BSS parameters change count is not included in FIG. 2D, as shown in, for example, FIG. 2E.

In the above example, since the AP supports the multi-link communication, the first subdomain may be set as the preset value for indicating the BSS change sequence is not present accordingly when the FD frame is generated. Further, the common information domain does not include the second subdomain indicating the BSS parameters change count. In this way, the AP is introduced for supporting the multi-link communication through FD frame, bit resources occupied by the FD frame are saved and high usability is achieved.

In some examples, if the AP does not support the multi-link communication, the RNR information element is not included in the FD frame, and a bit value included in the first subdomain may be set as “1” for indicating the BSS change sequence is present. Accordingly, the common information domain includes the second subdomain indicating the BSS parameters change count.

In some examples, the AP supports the multi-link communication, and the FD frame includes the RNR information element, and includes AP information of at least another AP attached to the AP MLD. In some examples, the common information domain, for example, a structure shown in FIG. 2D, of the first information element may not include a third subdomain indicating whether a multi-link capability is present, and the third subdomain may be an MLD capabilities subdomain, for example, as shown in FIG. 2F.

In the above example, when the FD frame includes the AP information of at least another AP affiliated with the AP MLD, the common information domain of the first information element may not include the third subdomain indicating whether the multi-link capability is present. In this way, bit resources occupied by the FD frame are saved and high usability is achieved.

Then, a device discovery solution according to the disclosure will be introduced below from an STA side.

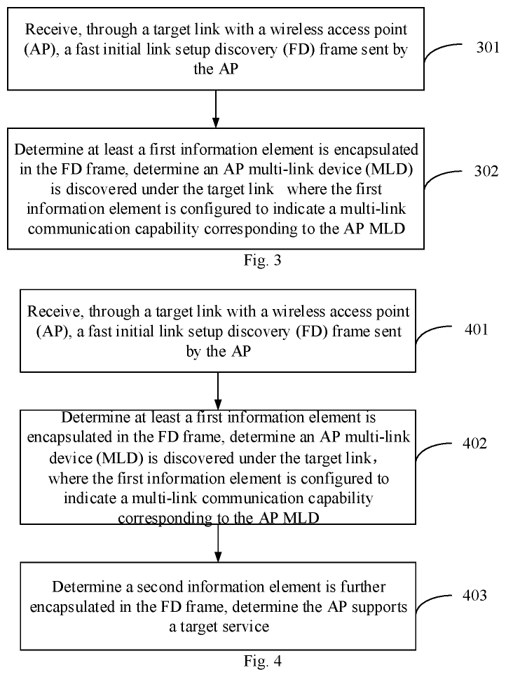

The example of the disclosure provides a device discovery method. With reference to FIG. 3, FIG. 3 is a flowchart of a device discovery method according to the example. The method may be performed by an STA. The method may include:

Step 301, a fast initial link setup discovery (FD) frame sent by the AP is received through a target link with a wireless access point (AP).

In the example of the disclosure, the STA may be an STA affiliated with an STA MLD. The STA may receive, through the target link with the AP, the FD frame sent by the AP.

Step 302, it is determined an AP MLD is discovered under the target link determining at least a first information element is encapsulated in the FD frame, where the first information element is configured to indicate a multi-link communication capability corresponding to the AP MLD.

In the above example, the STA MLD may rapidly discover the device based on the FD frame, and determine the AP supports the multi-link communication based on the first information element encapsulated in the FD frame. In this way, the AP MLD can be rapidly discovered under the target link, the multi-link communication is established subsequently, and high usability is achieved.

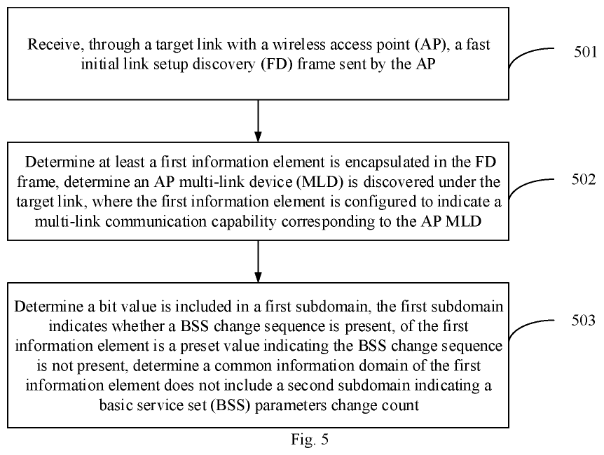

In some examples, the example of the disclosure provides a device discovery method. With reference to FIG. 4, FIG. 4 is a flowchart of a device discovery method according to the example. The method may be performed by an STA. The method may include:

Step 401, a fast initial link setup discovery (FD) frame sent by the AP is received through a target link with a wireless access point (AP).

In the example of the disclosure, the STA may be an STA affiliated with an STA MLD. The STA may receive, through the target link with the AP, the FD frame sent by the AP.

Step 402, it is determined an AP MLD is discovered under the target link determining at least a first information element is encapsulated in the FD frame, where the first information element is configured to indicate a multi-link communication capability corresponding to the AP MLD.

Step 403, it is determined the AP supports a target service determining a second information element is further encapsulated in the FD frame.

In the example of the disclosure, the second information element may be rTWT information element.

In a possible embodiment, the target service is a low-delay service including, but not limited to an autonomous driving service.

In the above example, a second information element is further encapsulated in an FD frame generated by the AP, the STA may determine the AP supports the target service based on the second information element, and high usability is achieved.

In some examples, the example of the disclosure provides a device discovery method. With reference to FIG. 5, FIG. 5 is a flowchart of a device discovery method according to the example. The method may be performed by an STA. The method may include:

Step 501, a fast initial link setup discovery (FD) frame sent by the AP is received through a target link with a wireless access point (AP).

In the example of the disclosure, the STA may be an STA affiliated with an STA MLD. The STA may receive, through the target link with the AP, the FD frame sent by the AP.

Step 502, it is determined an AP MLD is discovered under the target link determining at least a first information element is encapsulated in the FD frame, where the first information element is configured to indicate a multi-link communication capability corresponding to the AP MLD.

Step 503, it is determined a common information domain of the first information element does not include a second subdomain indicating a basic service set (BSS) parameters change count determining a bit value is included in a first subdomain, the first subdomain indicates whether a BSS change sequence is present, of the first information element is a preset value indicating the BSS change sequence is not present.

In the example of the disclosure, the first subdomain may be a BSS change sequence present subdomain, and the preset value may be “0” for indicating the BSS change sequence is not present. The second subdomain may be a BSS parameters change count subdomain.

In the above example, since the AP supports the multi-link communication, the first subdomain may be set as the preset value for indicating the BSS change sequence is not present accordingly when the FD frame is generated. Further, the common information domain does not include the second subdomain indicating the BSS parameters change count. In this way, the AP is introduced for supporting the multi-link communication through FD frame, bit resources occupied by the FD frame are saved and high usability is achieved.

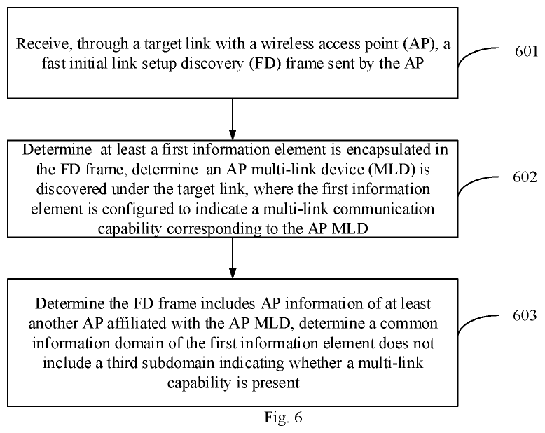

In some examples, the example of the disclosure provides a device discovery method. With reference to FIG. 6, FIG. 6 is a flowchart of a device discovery method according to the example. The method may be performed by an STA. The method may include:

Step 601, a fast initial link setup discovery (FD) frame sent by the AP is received through a target link with a wireless access point (AP).

In the example of the disclosure, the STA may be an STA affiliated with an STA MLD. The STA may receive, through the target link with the AP, the FD frame sent by the AP.

Step 602, it is determined an AP MLD is discovered under the target link determining at least a first information element is encapsulated in the FD frame, where the first information element is configured to indicate a multi-link communication capability corresponding to the AP MLD.

Step 603, it is determined a common information domain of the first information element does not include a third subdomain indicating whether a multi-link capability is present determining the FD frame includes AP information of at least another AP affiliated with the AP MLD.

The third subdomain may be MLD capabilities subdomain.

In the above example, when the FD frame includes the AP information of at least another AP affiliated with the AP MLD, the common information domain of the first information element may not include the third subdomain indicating whether the multi-link capability is present. In this way, bit resources occupied by the FD frame are saved and high usability is achieved.

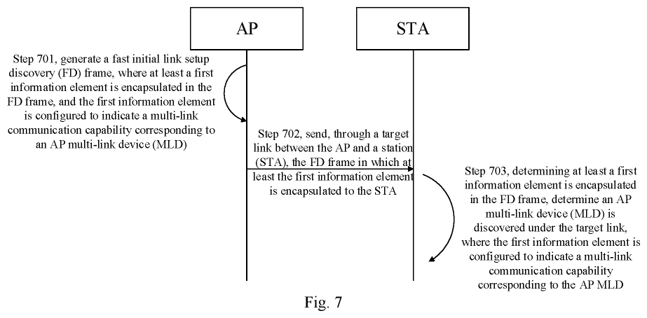

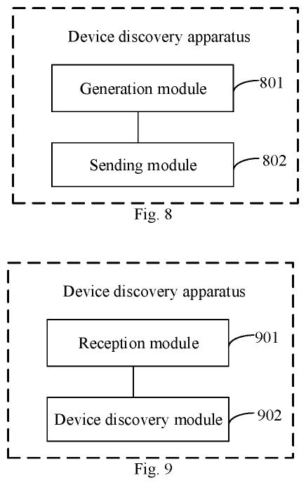

In some examples, with reference to FIG. 7, FIG. 7 is a flowchart of a device discovery method according to the example. The method may include:

Step 701, an AP supporting multi-link communication generates an FD frame.

At least a first information element is encapsulated in the FD frame, and the first information element is configured to indicate a multi-link communication capability corresponding to an AP multi-link device (MLD).

Step 702, the AP sends the FD frame in which at least the first information element is encapsulated to a station (STA) through a target link between the AP and the STA.

Step 703, it is determined an AP MLD is discovered under the target link the STA determining at least a first information element is encapsulated in the FD frame, where the first information element is configured to indicate a multi-link communication capability corresponding to the AP MLD.

In the above example, the AP MLD can be rapidly discovered by the STA MLD under one link, such that establishment of multi-link communication is facilitated.

Corresponding to the foregoing example of the method for implementing an application function, the disclosure further provides an example of an apparatus for implementing an application function.

With reference to FIG. 8, FIG. 8 is a block diagram of a device discovery apparatus according to an example. The apparatus is performed by a wireless access point (AP) supporting multi-link communication, and includes:
a generation module 801 configured to generate a fast initial link setup discovery (FD) frame, where at least a first information element is encapsulated in the FD frame, and the first information element is configured to indicate a multi-link communication capability corresponding to an AP multi-link device (MLD); and
a sending module 802 configured to send the FD frame in which at least the first information element is encapsulated to a station (STA) through a target link between the AP and the STA.

With reference to FIG. 9, FIG. 9 is a block diagram of another device discovery apparatus according to an example. The apparatus is performed by a station (STA), and includes:
a reception module 901 configured to receive, through a target link with a wireless access point (AP), a fast initial link setup discovery (FD) frame sent by the AP; and
a device discovery module 902 configured to determine an AP multi-link device (MLD) is discovered under the target link determining at least a first information element is encapsulated in the FD frame, where the first information element is configured to indicate a multi-link communication capability corresponding to the AP MLD.

As for the example of the apparatus, since this example basically corresponds to the example of the method, reference can be made to partial description of the example of the method for relevant contents. The example of the apparatus described above is illustrative, the cells described as separated components can be physically separated or not, and the components displayed as the cells can be physical cells or not, that is, the cells or the components can be located in one place or distributed over a plurality of network cells. Some or all of the modules can be selected according to actual needs to achieve the objectives of the solutions of the disclosure. What is described above can be understood and implemented by those skilled in the art without creative efforts.

Accordingly, the disclosure further provides a non-transitory computer-readable storage medium. The non-transitory computer-readable storage medium stores a computer program, where the computer program is configured to execute any said device discovery method at an AP side.

Accordingly, the disclosure further provides a non-transitory computer-readable storage medium. The non-transitory computer-readable storage medium stores a computer program, where the computer program is configured to execute any said device discovery method at an STA side.

Accordingly, the disclosure further provides a first device discovery apparatus. The device discovery apparatus includes:
a first processor; and
a first memory configured to store a processor-executable instruction; where
the first processor is configured to execute any said device discovery method at an AP side.

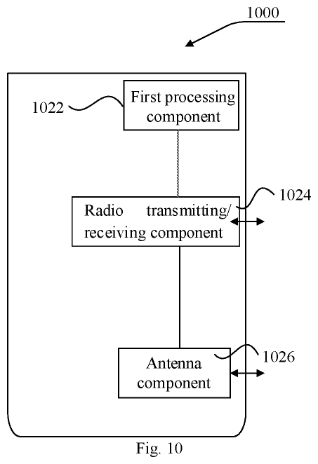

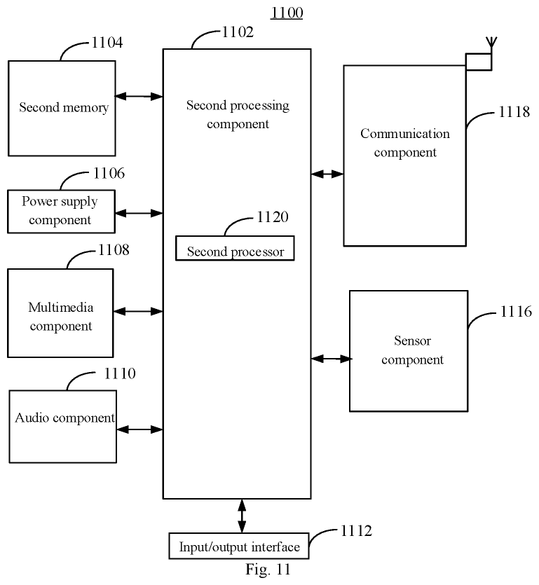

As shown in FIG. 10, FIG. 10 is a schematic structural diagram of a first device discovery apparatus 1000 according to an example. The apparatus 1000 may be provided as an AP supporting multi-link communication. With reference to FIG. 10, the apparatus 1000 includes a first processing component 1022, a radio transmitting/receiving component 1024, an antenna component 1026, and a signal processing portion unique to a radio interface, and the first processing component 1022 may further include at least one first processor.

One first processor in the first processing component 1022 may be configured to execute any said device discovery method.

Accordingly, the disclosure further provides a second device discovery apparatus. The second device discovery apparatus includes:
a second processor; and
a second memory configured to store a processor-executable instruction; where
the second processor is configured to execute any said device discovery method at an STA side.

FIG. 11 is a block diagram of a second device discovery apparatus 1100 according to an example. For example, the second device discovery apparatus 1100 can be an STA, including but not limited to a mobile phone, a tablet computer, an e-book reader, a multimedia playback device, a wearable device, a vehicle-mounted user device, an ipad, a smart TV and other terminals.

With reference to FIG. 11, the second device discovery apparatus 1100 may include one or more of a second processing component 1102, a second memory 1104, a power supply component 1106, a multimedia component 1108, an audio component 1110, an input/output (I/O) interface 1112, a sensor component 1116, and a communication component 1118.

Generally, the second processing component 1102 controls an overall operation of the second device discovery apparatus 1100, such as an operation associated with display, a telephone call, random data access, a camera operation, and a recording operation. The second processing component 1102 may include one or more second processors 1120 for executing an instruction, and completing all or some of the steps of the above device discovery method. In addition, the second processing component 1102 may include one or more modules to facilitate interaction between the second processing component 1102 and other components. For example, the second processing component 1102 may include a multimedia module to facilitate interaction between the multimedia component 1108 and the second processing component 1102. For example, the second processing component 1102 may read an executable instruction from the memory to implement steps of the device discovery methods according to the above examples.

The second memory 1104 is configured to store various types of data to support the operation by the second device discovery apparatus 1100. Instances of such data include instructions for any application or method operated on the device discovery apparatus 1100, contact data, phonebook data, messages, pictures, videos, etc. The second memory 1104 may be implemented by any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 1106 energizes various components of the second device discovery apparatus 1100. The power supply component 1106 may include a power supply management system, one or more power supplies, and other components associated with power generation, management, and distribution for the second device discovery apparatus 1100.

The multimedia component 1108 includes a screen providing an output interface between the second device discovery apparatus 1100 and a user. In some examples, the multimedia component 1108 includes a front-facing camera and/or a rear-facing camera. When the second device discovery apparatus 1100 is in an operation mode, for example, a photographing mode or a video mode, the front-facing camera and/or the rear-facing camera may receive external multimedia data. Each of the front-facing camera and the rear-facing camera may be a constant optical lens system or have a variable focal length and optical zoom capacity.

The audio component 1110 is configured to output and/or input an audio signal. For example, the audio component 1110 includes a microphone (MIC). The microphone is configured to receive an external audio signal when the second device discovery apparatus 1100 is in an operation mode such as a call mode, a recording mode or a speech identification mode. The received audio signal may be further stored in the second memory 1104 or sent via the communication component 1118. In some examples, the audio component 1110 further includes a speaker for outputting audio signals.

The I/O interface 1112 provides an interface between the second processing component 1102 and a peripheral interface module. The peripheral interface module may be a keyboard, a click wheel, a button, etc. These buttons may include, but are not limited to: a home button, a volume button, a start button, and a lock button.

The sensor component 1116 includes one or more sensors for providing status evaluation in various aspects for the second device discovery apparatus 1100. For example, the sensor component 1116 may detect an on/off state of the second device discovery apparatus 1100, and relative positioning of components, for example, the components are a display and a keypad of the second device discovery apparatus 1100. The sensor component 1116 may also detect a change in position of the second device discovery apparatus 1100 or a component of the second device discovery apparatus 1100, presence or absence of contact between the user and the second device discovery apparatus 1100, orientation or acceleration/deceleration of the second device discovery apparatus 1100, and a temperature change of the second device discovery apparatus 1100. The sensor component 1116 may include a proximity sensor configured to detect presence of a nearby object without any physical contact. The sensor component 1116 may further include an optical sensor, such as a complementary metal-oxide-semiconductor transistor (CMOS) or charge-coupled device (CCD) image sensor, for use in imaging applications. In some examples, the sensor component 1116 may further include an acceleration sensor, a gyroscope sensor, a magnetic sensor, a pressure sensor, or a temperature sensor.

The communication component 1118 is configured to facilitate wired or wireless communication between the second device discovery apparatus 1100 and other devices. The second device discovery apparatus 1100 may access a wireless network based on a communication standard, such as Wi-Fi, 2G, 3G, 4G, 5G, 6G or their combinations. In an example, the communication component 1118 receives a broadcast signal or related broadcast information from an external broadcast management system via a broadcast channel. In an example, the communication component 1118 further includes a near field communication (NFC) module to promote short-range communication. For example, the NFC module may be implemented based on a radio frequency identification (RFID) technology, an infrared data association (IrDA) technology, an ultra-wide band (UWB) technology, a Bluetooth (BT) technology, etc.

In an example, the second device discovery apparatus 1100 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic elements for executing any said device discovery method at the STA side.

In an example, a non-transitory machine-readable storage medium including an instruction is further provided, such as the second memory 1104 including an instruction. The instruction may be executed by the second processor 1120 of the second device discovery apparatus 1100 for implementing the device discovery method. For example, the non-transitory computer-readable storage medium may be a read only memory (ROM), a random access memory (RAM), a CD-ROM, a magnetic tape, a floppy disc, an optical data storage device, etc.

Those skilled in the art could easily conceive of other implementation solutions of the disclosure after considering the description and the invention disclosed here. The disclosure intends to cover any variation, use or adaptive change of the disclosure, which follows general principles of the disclosure and includes common general knowledge or conventional technical means in the technical field not disclosed in the disclosure. The description and the examples are considered illustrative, and a true scope and spirit of the disclosure are indicated by the following claims.

It should be understood that the disclosure is not limited to precise structures described above and shown in the accompanying drawings, and various modifications and changes can be made without departing from the scope of the disclosure. The scope of the disclosure is limited by the appended claims.

1. A device discovery method, performed by a wireless access point (AP) supporting multi-link communication, and comprising:
generating a fast initial link setup discovery (FD) frame, wherein at least a first information element is encapsulated in the FD frame, and the first information element is configured to indicate a multi-link communication capability corresponding to an AP multi-link device (MLD); and
sending, through a target link between the AP and a station (STA), the FD frame in which at least the first information element is encapsulated to the STA.

2. The device discovery method according to claim 1, wherein a second information element is further encapsulated in the FD frame, and the second information element is configured to indicate support for a target service.

3. The device discovery method according to claim 2, wherein the target service is a low-delay service.

4. The device discovery method according to claim 1, wherein a reduced neighbor report (RNR) information element is further encapsulated in the FD frame, the first information element at least comprises a first subdomain indicating whether a basic service set (BSS) change sequence is present, a bit value comprised in the first subdomain is a preset value, and the preset value is configured to indicate the BSS change sequence is not present.

5. The device discovery method according to claim 4, wherein a common information domain of the first information element does not comprise a second subdomain indicating a BSS parameters change count.

6. The device discovery method according to claim 1, wherein the FD frame comprises AP information of at least another AP affiliated with the AP MLD, and a common information domain of the first information element does not comprise a third subdomain indicating whether a multi-link capability is present.

7. A device discovery method, performed by a station (STA), and comprising:
receiving, through a target link with a wireless access point (AP), a fast initial link setup discovery (FD) frame sent by the AP; and
determining at least a first information element is encapsulated in the FD frame, determining an AP multi-link device (MLD) is discovered under the target link, wherein the first information element is configured to indicate a multi-link communication capability corresponding to the AP MLD.

8. The device discovery method according to claim 7, further comprising:
determining a second information element is further encapsulated in the FD frame, determining the AP supports a target service.

9. The device discovery method according to claim 8, wherein the target service is a low-delay service.

10. The device discovery method according to claim 7, further comprising:
determining a bit value is comprised in a first subdomain, the first subdomain indicates a basic service set (BSS) change sequence is present, of the first information element is a preset value, determining a common information domain of the first information element docs not comprise a second subdomain indicating a BSS parameters change count wherein the preset value is configured to indicate the BSS change sequence is not present.

11. The device discovery method according to claim 7, further comprising:
determining the FD frame comprises AP information of at least another AP affiliated with the AP MLD, determining a common information domain of the first information element does not comprise a third subdomain indicates whether a multi-link capability is present.

12. (canceled)

13. (canceled)

14. A non-transitory computer-readable storage medium, storing a computer program, wherein the computer program is configured to execute the device discovery method according to claim 1.

15. A non-transitory computer-readable storage medium, storing a computer program, wherein the computer program is configured to execute the device discovery method according to claim 7.

16. A first device discovery apparatus, comprising:
a first processor; and
a first memory configured to store a processor-executable instruction; wherein
the first processor is configured to;
generate a fast initial link setup discovery (FD) frame, wherein at least a first information element is encapsulated in the FD frame, and the first information element is configured to indicate a multi-link communication capability corresponding to an access point (AP) multi-link device (MLD); and
send, through a target link between the AP and a station (STA), the FD frame in which at least the first information element is encapsulated to the STA.

17. A second device discovery apparatus, comprising:
a second processor; and
a second memory configured to store a processor-executable instruction; wherein
the second processor is configured to execute the device discovery method according to claim 7.

18. The first device discovery apparatus according to claim 16, wherein a second information element is further encapsulated in the FD frame, and the second information element is configured to indicate support for a target service.

19. The first device discovery apparatus according to claim 18, wherein the target service is a low-delay service.

20. The first device discovery apparatus according to claim 16, wherein a reduced neighbor report (RNR) information element is further encapsulated in the FD frame, the first information element at least comprises a first subdomain indicating whether a basic service set (BSS) change sequence is present, a bit value comprised in the first subdomain is a preset value, and the preset value is configured to indicate the BSS change sequence is not present.

21. The first device discovery apparatus according to claim 20, wherein a common information domain of the first information element does not comprise a second subdomain indicating a BSS parameters change count.

22. The first device discovery apparatus according to claim 16, wherein the FD frame comprises AP information of at least another AP affiliated with the AP MLD, and a common information domain of the first information element does not comprise a third subdomain indicating whether a multi-link capability is present.
